(19) United States
(12) Patent Application Publication
(10) Pub. No.: US 2009/0119874 A1
(43) Pub. Date: May 14, 2009

(54) Snap-On Window Balance Terminal Clip

(75) Inventors: Wilbur J. Kellum, III, Hilton, NY (US); Frederick W. Dietzel, Walkersville, MD (US)

Correspondence Address: BROWN & MICHAELS, PC;400 M & T BANK BUILDING, 118 NORTH TIOGA ST, ITHACA, NY, 14850, US

(73) Assignee: CALDWELL MANUFACTURING COMPANY, Rochester, NY (US)

(21) Appl. No.: 11/938,387

(22) Filed: Nov. 12, 2007

(51) Int. Cl. E05D 13/00

(52) U.S. Cl. 16/197

(57) ABSTRACT

A snap-on terminal clip for installation onto the end of the spiral rod of a spiral rod window balance. The upper region of the terminal clip lockingly engages a locking pin secured to the external end of the spiral rod. The lower region of the clip terminates in a substantially hook shaped segment that engages the ledge of a window sash, thereby supporting the sash as it moves vertically through the jamb channel of the window assembly.

### FIELD OF THE INVENTION

The invention pertains to the field of window balances. Particularly, the invention pertains to a clip attached to the exposed rod end of a spiral rod balance. The clip then connects the spiral balance to a window sash by snapping over a pin secured to the end of the spiral rod.

### BACKGROUND OF THE INVENTION

Window assemblies may include a single sash or two sashes, which are referred to, respectively, as single hung or double hung windows. A window assembly generally includes a window frame, at least one sash, a pair of opposing window jambs, each jamb having a channel for allowing the vertical travel of each sash, and at least one window balance to assist with the raising and lowering of the sash to which it is attached by counterbalancing the weight of the sash.

Springs are utilized to provide the counterbalance force. In spiral rod balances, a torsion spring provides a substantially constant lifting force over the full travel of the sash through the jamb channel. The torsional spring force is converted into a lifting force by an elongated spiral rod. The torsion spring and elongated spiral rod are all housed within a containment tube which protects the moving parts of the balance from contamination. The containment tube has an open end and a closed end. The closed end of the containment tube is secured to the jamb channel, for example, by a bolt, screw, rivet or other fastener, depending on the design preferences of the window manufacturer. The open end of the containment tube is capped by a rotatable coupling having a center slot through which the elongated spiral rod travels. When the spiral rod protruding from the open end of the containment tube is attached to a window sash, depending on the direction of vertical movement required to open the window, the spiral rod is either extended or retracted. For example, in a double hung window design the upper sash moves downward to open the window and the lower sash moves upward to open the window.

In pivoting window sashes, the spiral rod connects to a shoe or carrier which traverses up and down the jamb channel of the window assembly. The window sash and window balance are linked together through the shoe/carrier by means of a pivot bar which extends from an end of each stile of the sash.

Alternatively, the end of the spiral rod may attach directly to the sash itself. In this case, a clip is securely attached to the end of the spiral rod. The conventional means of attaching the clip to the spiral rod consists of the use of a rivet. Whether the spiral rod balance is attached to a shoe or to the sash requires a different configuration of the spiral rod. In the instance where the spiral rod balance is attached to the shoe, only a pin is required at the end of the rod. However, if the spiral rod balance is to be attached to the sash, the clip needs to be securely fitted to the end of the rod. Since window manufacturers utilize both designs, the balance manufacturer must inventory two different spiral rods, even though the remainder of the balance components are the same. It is desirable, therefore, to have a single spiral rod that can be readily adapted for use with either spiral rod balance assembly. What is needed is a terminal clip that can be easily installed onto the end of a universal pinned spiral rod without the need for a riveting operation as is now conventionally done.

### SUMMARY OF THE INVENTION

The present device is a terminal clip and a method for its installation onto the end of the spiral rod of a spiral rod window balance. The terminal clip uses the spring like memory of the material used to make the terminal clip to snap over a locking pin secured to the exposed end of the spiral rod.

The method of installing the terminal clip onto a spiral rod includes the steps of first orienting the snap element of the terminal clip in the direction of the locking pin in the spiral rod. The snap element of the terminal clip then slides over the locking pin, snapping the terminal clip semi-permanently onto the spiral rod. If necessary, the terminal clip may be removed from the spiral rod by forcibly disengaging the snap element.

### BRIEF DESCRIPTION OF THE DRAWING

FIG. 1A shows a perspective view of a first embodiment of the terminal clip of the invention.

FIG. 1B shows a plan view of the terminal clip of FIG. 1A from the top of the clip.

FIG. 2 shows the terminal clip of FIG. 1A being oriented to hook onto the end of the spiral rod of a spiral rod balance.

FIG. 3 shows the initial engagement of the terminal clip of FIG. 2 with the locking pin at the end of the spiral rod.

FIG. 4 shows another view of the initial engagement step of FIG. 3.

FIG. 5 shows the rotation of the first embodiment of the terminal clip as it pivots around the locking pin at the end of the spiral rod.

FIG. 6 shows one perspective view of the terminal clip of FIG. 5 locked onto the end of the spiral rod.

FIG. 7 shows another perspective view of the terminal clip of FIG. 6 locked onto the end of the spiral rod.

FIG. 8A shows a cut out of a window sash to which the first embodiment of the terminal clip is attached.

FIG. 8B shows a close up view of FIG. 8A.

FIG. 9A shows an exposed detail of a spiral balance within the jamb channel of a window assembly in which the first embodiment terminal clip is locked in place onto the end of the spiral rod.

FIG. 9B shows a close up of FIG. 9A.

FIG. 10A shows a second embodiment of the terminal clip.

FIG. 10B shows the terminal clip of FIG. 10A in the initial stages of installation around the locking pin of a spiral rod.

FIG. 10C shows the terminal clip of FIGS. 10A and 10B snapped around the locking pin in semi-permanent engagement with the spiral rod.

FIG. 10D shows an isometric view of the second embodiment of the terminal clip fully installed on the end of the spiral rod.

### DETAILED DESCRIPTION OF THE INVENTION

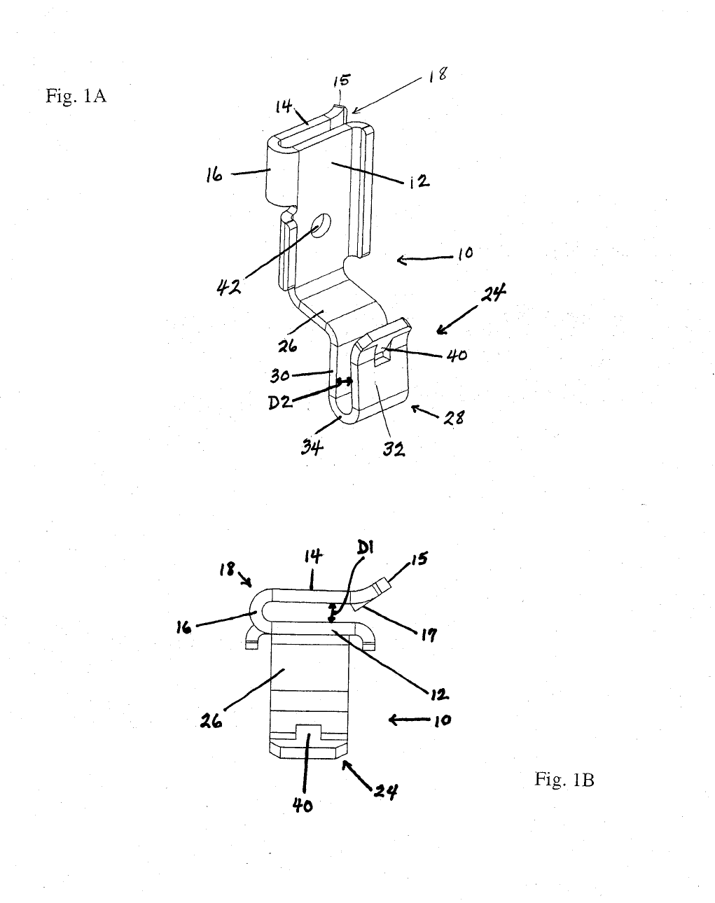

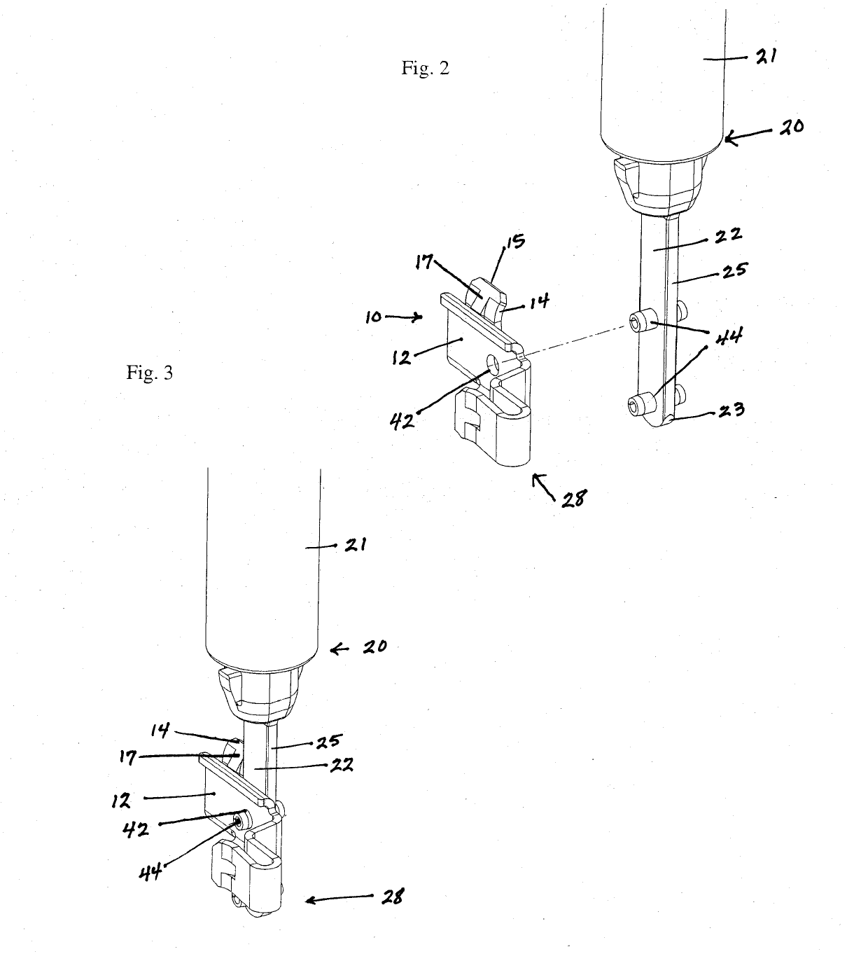

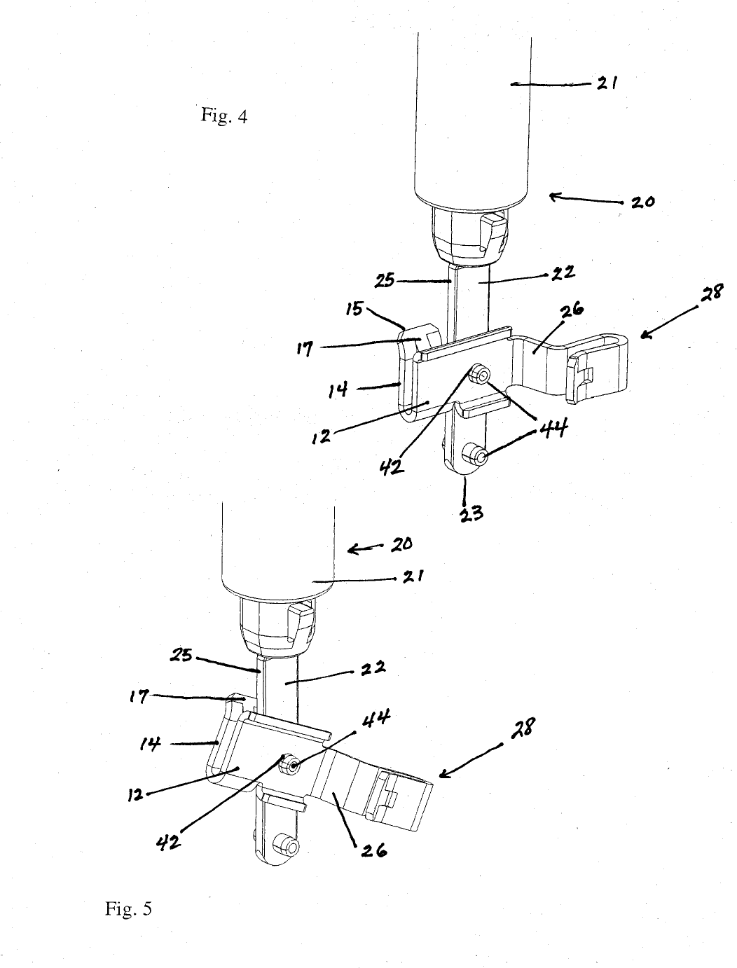

FIGS. 1A through 9B pertain to a first embodiment of the snap-on terminal clip of the invention. FIGS. 1A and 1B show the first embodiment of the snap-on terminal clip 10 which consists of a primary structural support 12 linked to a rear wall 14 by an integral “U” shaped linkage 16 proximate a first end region 18 of the terminal clip 10. The rear wall 14 is shorter than the primary structural support 12 and is disposed proximate the first end region 18. The rear wall 14 and the primary structural support 12 are substantially coplanar and are separated from each other by a distance “D1” which is approximately equal to the thickness of the spiral rod 22 of a conventional spiral rod window balance 20 (see FIGS. 2 and 3). Located proximate the end 15 of the rear wall 14 is a first upset locking tab 17. The function of the first locking tab 17 will be explained later.

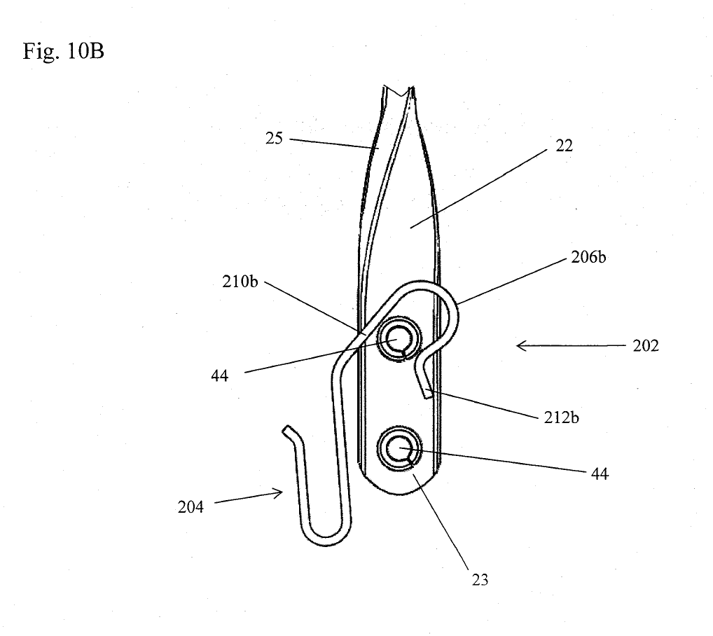

A second end region 24 of the terminal clip 10 is integrally connected to the primary structural support 12 by a linking platform 26. The plane of the primary structural support 12 is disposed approximately 90 degrees from the plane of the linking platform 26. Linking platform 26 terminates in a sash interface region 28. The sash interface region 28 consists of an inner wall segment 30 and an outer wall segment 32 which are substantially coplanar with each other. The inner wall segment 30 is integrally joined to the outer wall segment 32 by a substantially “U” shaped segment 34. The distance “D2” between the outer wall segment and the inner wall segment is substantially equal to the thickness of a retaining ledge 36 on window sash 38 (see FIGS. 8A and 8B). The outer wall segment 32 may have an optional second upset tab 40 which may either fit into a mating slot on the surface of the retaining ledge 36 (not shown) or may simply provide an interference fit with the surface of the retaining ledge 36 to help secure the sash 38 within the walls 30 and 32 of the sash interface region 28.

The terminal clip 10 may be made from a variety of materials so long as it is able to provide the necessary strength to support the weight of the sash. It is also preferable that the material chosen have some degree of structural memory in order for the wall segments 30 and 32 to flex slightly away from each other as the terminal clip 10 is first connected to the retaining ledge 36 of the sash 38 and then substantially return to their resting position to provide an interference fit to insure the continuous retention of the sash 38 within the terminal clip 10. Suitable materials include formed sheet metal, die cast metal or molded plastics and resins, such as Nylon 66.

The primary structural support 12 has a hole 42 that is located in a portion of the surface of the primary structural support 12 that is not adjacent the rear wall 14. Referring to FIGS. 2 through 7, the method of installing the terminal clip 10 to the spiral rod window balance 20 is shown. A conventional spiral rod balance 20 contains a spiral rod 22. In operation, the spiral rod 22 is pulled from the containment tube 21 as the sash is moved either up or down away from its resting position. The torsion spring (not shown) within the containment tube 21 is fixed at the top end of the containment tube where its free end can wind and unwind within the containment tube 21 by means of being attached to the rotatable coupling located at the bottom of the containment tube 21. The spiral rod 22 is constrained within the torsion spring which is within the containment tube 21 and as the rod is pulled out of the spiral balance 20 through the center slot of the coupling, the coupling rotates with respect to the containment tube 21 and gradually tightens the torsion spring, thus providing the incremental increase in resistance to counter the weight of the sash and assist in the vertical movement of the sash through the jamb channel of the window frame. The terminal clip 10 prevents the rotation of the external end 23 of the spiral rod 22 relative to the sash 38 by securing the spiral rod 22 to the retaining ledge 36 of the sash 38.

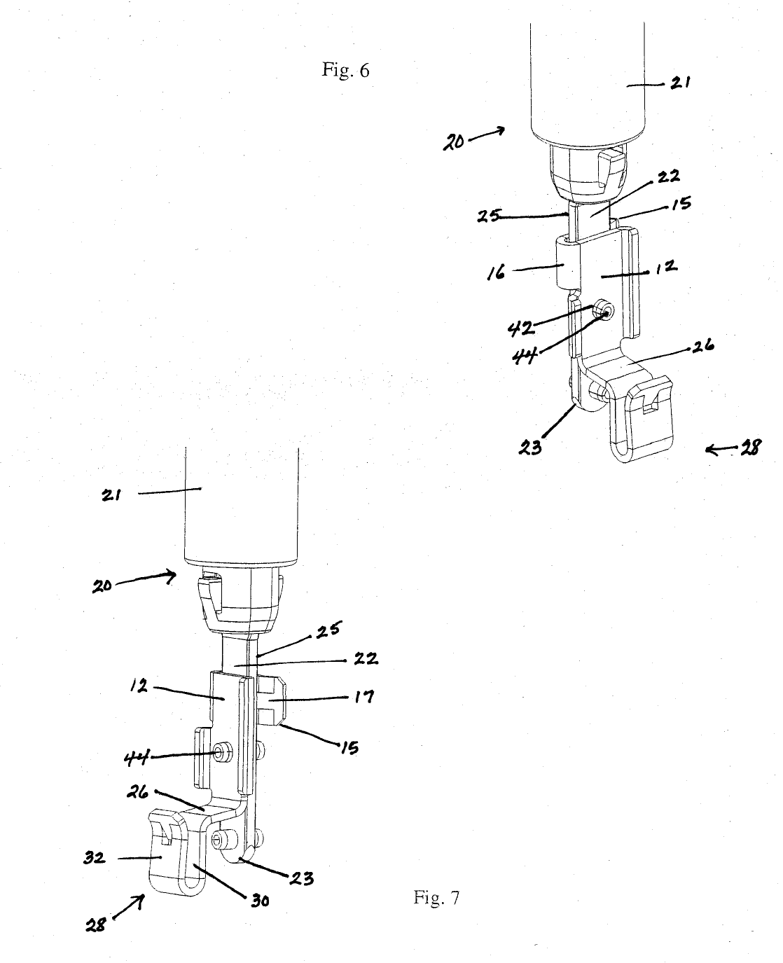

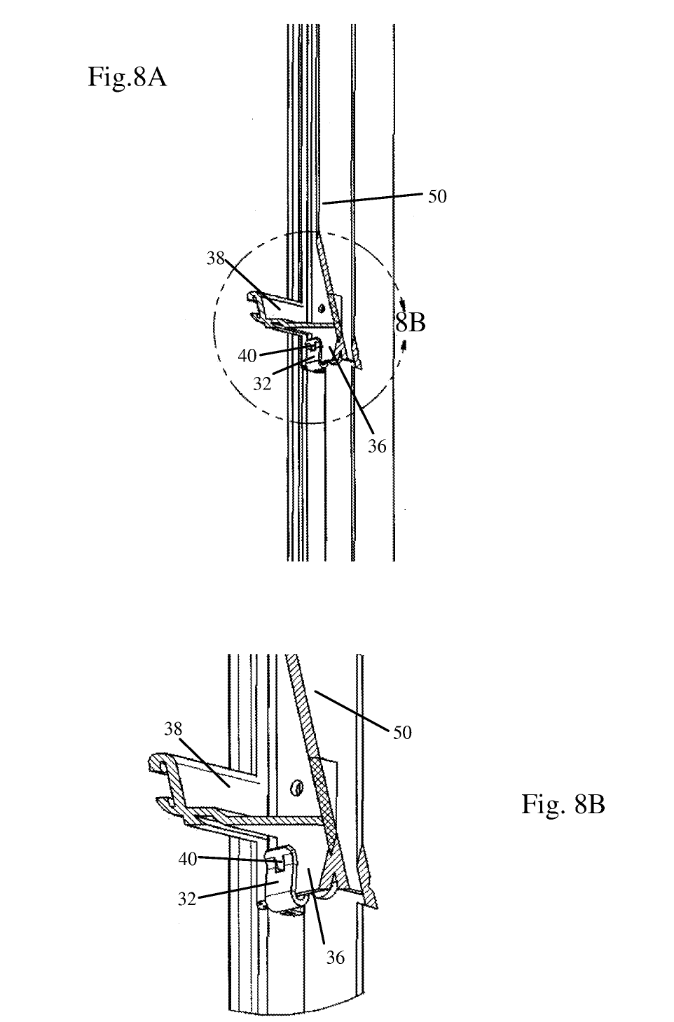

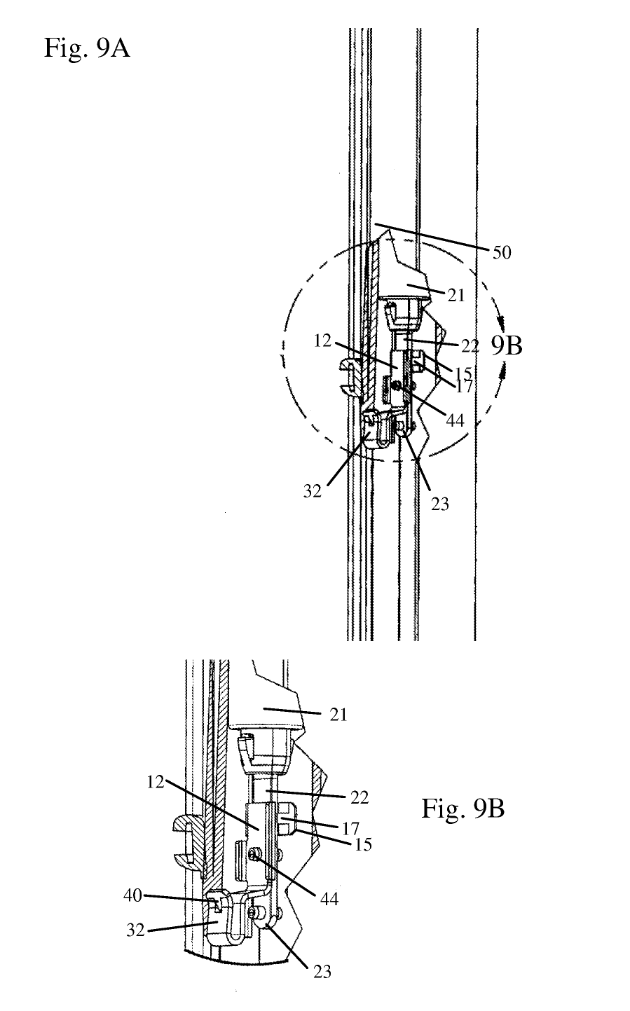

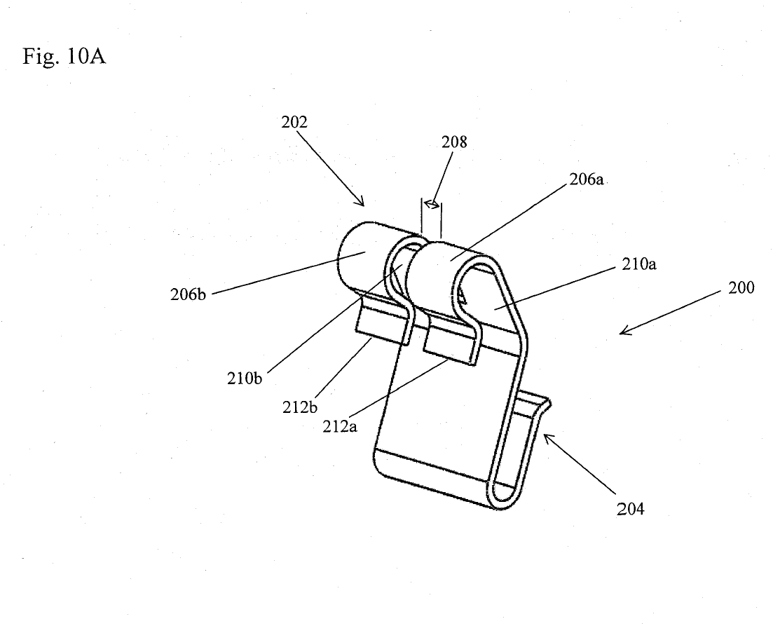

To assemble the terminal clip 10 to the spiral balance 20, hole 42 of the terminal clip is first aligned with one of the locking pins 44 securely fixed to the external end 23 of the spiral rod 20 with the rear wall 14 facing the spiral rod, as shown in FIG. 2. As shown in FIG. 3, one of the locking pins 44 is inserted through hole 42 (see FIG. 4, also). Once the hole 42 and locking pin 44 are connected, the terminal clip 10 is rotated about the axis of the locking pin 44 so that the spiral rod 22 is captured between the primary structural support 12 and the rear wall 14. The beginning of the rotation movement of the terminal clip is best seen in FIG. 5. Once the spiral rod 20 is completely encapsulated within the gap between the rear wall 14 and the primary support structure 12, the first locking tab 17 snaps around the edge 25 of the spiral rod 22, thereby securely locking the terminal clip 10 to the spiral rod, as shown in FIGS. 6 and 7. The attachment of the terminal clip 10 to a spiral rod balance 20, converts what is traditionally called a pinned balance to a flexure “clip-on” rod end balance. This is because the balance does not require an adapter to attach it to the sash. The “U” shaped sash interface region 28 of the terminal clip 10 provides a simple yet effective means for securing the balance to the sash.

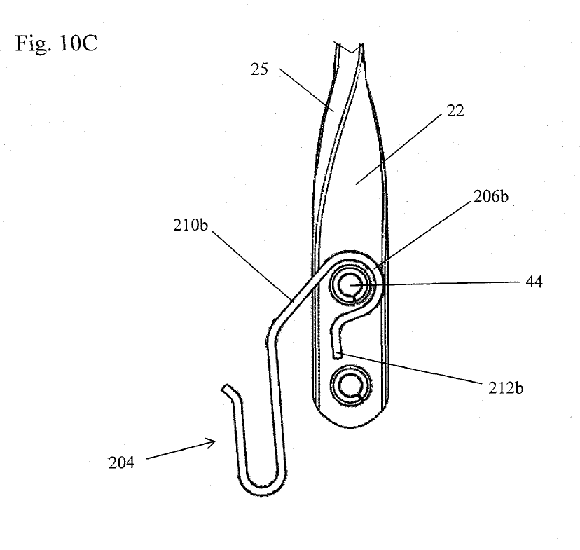

Referring to FIGS. 8A and 8B, a spiral rod balance 20 is shown installed within the jamb channel 50 of a window frame. Retaining ledge 36 of sash 38 is shown as being secured within the sash interface region 28 of terminal clip 10. A breakaway view of the clip-on rod end balance installed within a jamb channel is shown in FIGS. 9A and 9B. The retention of the terminal clip 10 to the retaining ledge 36 of the sash 38 enables the balance to assist with the vertical movement of the sash through its vertical travel within the jamb channel.

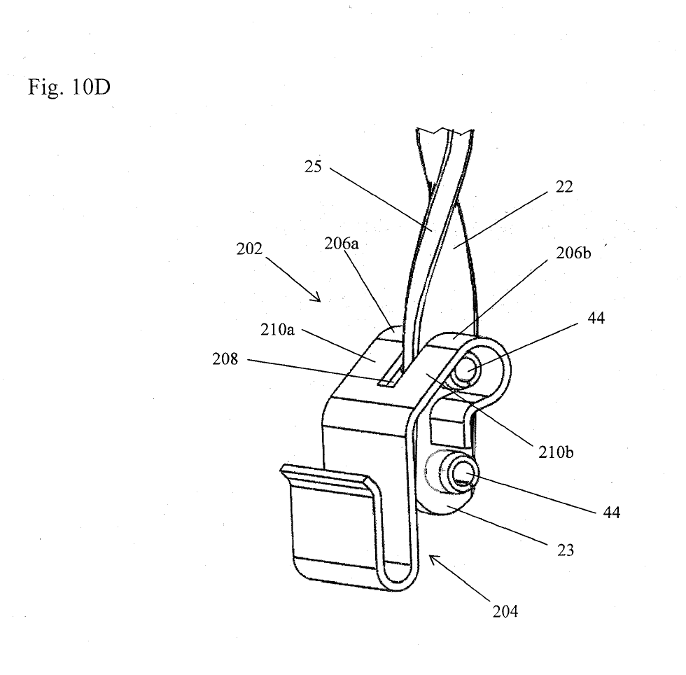

A second embodiment of the snap-on terminal clip is shown in FIGS. 10A-10D. Referring to the side views of FIGS. 10B and 10C, the “S” shaped configuration of the second embodiment snap-on terminal clip 200 is best observed. The snap-on terminal clip 200 consists of a spiral rod interface region 202 and a sash interface region 204. The spiral rod interface region 202 consists of two parallel flexible hook segments 206a and 206b. The flexible hook segments are separated by a channel 208. The width of channel 208 approximates the thickness of the spiral rod 20. Each flexible hook segment 206a and 206b has a main structural support region 210a and 210b, respectively. Each structural support region extends in a circular path, when viewed from the side, traversing in a more than 180 degree angle relative to the plane of its respective structural support region to terminate in ends 212a and 212b, respectively. The ends 212a and 212b are flared out away from their respective main structural support regions to facilitate engagement with locking pins 44. The diameter formed by the circular path of the flexible hook segments 206a and 206b approximates the outer diameter of the locking pins 44 of the spiral rod 22. The distance between the terminal ends 212a and 212b and their respective main structural support regions 210a and 210b is less than the diameter of the locking pins 44, so that after engagement between the snap-on terminal clip 200 and one of the locking pins 44, the snap-on terminal clip is semi-permanently engaged on the locking pin 44. As with the first embodiment of the snap-on terminal clip 10, the material from which the second embodiment of the snap-on terminal clip is made includes formed sheet metal, die cast metal, molded plastics and resins, such as Nylon 66. One of the requirements for the choice of materials is that it has a structural memory that allows it to flex when needed and yet return substantially to its original form after flexure.

Referring to FIG. 10B, the snap-on terminal clip 200 is shown as it begins to be snapped over the locking pin 44 of the spiral rod 20. The channel 208 is lined up with an edge 25 of the spiral rod 22. The terminal ends 212a and 212b are forced to flex around the diameter of the locking pin 44. In FIG. 10C, the terminal ends 212a and 212b have passed beyond the locking pin 44, thus snapping the snap-on terminal clip 200 semi-permanently over the locking pin 44. Note that with respect to the second embodiment of the snap-on terminal clip 200, the snap-on terminal clip is allowed to rotate to some degree around the axis of the locking pin 44. This feature is helpful when the time comes to engage the sash engagement region 204 with a window sash 36 (please refer to FIGS. 8A and 8B for a view of the sash). FIG. 10D is an isometric view of the second embodiment of the snap-on terminal clip 200 secured to the end of the spiral rod 20 of a spiral rod balance 20. The snap-on terminal clip 200 may be disengaged from the spiral rod by forcibly separating the terminal ends 212a and 212b from their structural support regions 210a and 210b and sliding the snap-on terminal clip 200 off of the locking pin 44.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A snap-on terminal clip for semi-permanently connecting to a locking pin which is secured to an external end of a spiral rod of a spiral rod window balance comprising:
a) means for semi-permanently engaging the locking pin; and
b) a hooked shaped region for attachment to an edge of a window sash.

2. The snap-on terminal clip of claim 1 comprising:
a) a substantially planar primary structural support having a first end, a second end, a front surface and a rear surface;
b) a rear wall substantially coplanar with the rear surface of and integrally attached to the first end of the primary structural support proximate the first end of the primary structural support, wherein the primary structural support is larger than the rear wall;
c) a linking platform having a first end and a second end, the first end integrally connected to and extending from the second end of primary structural support, the plane of the linking platform disposed substantially 90 degrees from the plane of the primary structural support; and
d) a sash interface region integrally connected to and extending from the second end of the linking platform.

3. The clip of claim 2 wherein the sash engagement region contains an inner wall segment integrally formed with and substantially coplanar with an outer wall segment.

4. The clip of claim 2 wherein the primary structural support contains a hole that is positioned so that it is not aligned with the rear wall.

5. The clip of claim 2 wherein the rear wall contains a first upset tab disposed toward the rear surface of the primary structural support.

6. The clip of claim 4 wherein the outer wall segment contains a second upset tab disposed toward the inner wall segment.

7. A method for attaching the snap-on terminal clip of claim 1 to an external end of a spiral rod of a spiral rod window balance, having a locking pin located proximate the end of the spiral rod, comprising the steps of:
a) orienting the rear surface of the primary structural support toward the external end of the spiral rod;
b) aligning a hole in the primary structural support with the locking pin on the spiral rod;
c) engaging the hole with the locking pin;
d) rotating the clip substantially 90 degrees so that the spiral rod slides between the primary structural support and the rear wall until the first upset tab snaps over an edge of the spiral rod.

8. The snap-on terminal clip of claim 1 having a substantially “S” shaped configuration when viewed from the side comprising:
a) a spiral rod interface region; and
b) a sash interface region.

9. The snap-on terminal clip of claim 8 wherein the spiral rod interface region consists of a substantially planar structural support region integrally connected to two flexible hook segments that each traverse in a coincidental substantially circular path from the structural support region, each flexible hook segment terminating in an end that flares out and away from the structural support region.

10. The snap-on terminal clip of claim 9 wherein the inner diameter of the circular path of each of the flexible hook segments substantially approximates the outer diameter of the locking pins and the flared out ends are separated from the structural support region by a distance that is less than the diameter of the locking pins.

11. The snap-on terminal clip of claim 10 further comprising a channel separating the two flexible hook segments, the width of the channel substantially approximating the thickness of the spiral rod.

12. The snap-on terminal clip of claim 8 wherein the sash interface region is hook shaped.

13. A method for installing the snap-on terminal clip of claim 8 onto the external end of a spiral rod of a spiral rod balance, the external end of the spiral rod having at least one securely affixed locking pin, comprising the sequential steps of:
a) aligning the channel of the snap-on terminal clip to engage the spiral rod; and
b) forcing both flexible hook shaped segments over one of the locking pins until the flared ends of the flexible hook shaped segments snap around the locking pin.
